(19) United States
(12) Patent Application Publication
(10) Pub. No.: US 2009/0328148 A1
(43) Pub. Date: Dec. 31, 2009

(54) METHOD OF TRUST MANAGEMENT IN WIRELESS SENSOR NETWORKS

(75) Inventors: Sung Young LEE, Seongnam-si (KR); Young Koo LEE, Suwon-si (KR); Riaz Ahmed SHAIKH, Yongin-si (KR)

Correspondence Address: SHERIDAN ROSS PC, 1560 BROADWAY, SUITE 1200, DENVER, CO, 80202, US

(73) Assignee: INDUSTRY-ACADEMIC COOPERATION FOUNDATION OF KYUNG HEE UNIVERSITY, Yongin-si (KR)

(21) Appl. No.: 12/178,722

(22) Filed: Jul. 24, 2008

(30) Foreign Application Priority Data
Jun. 30, 2008 (KR) 10-2008-0063001

(51) Int. Cl. G06F 21/00; G06F 17/11

(52) U.S. Cl. 726/3; 708/446

(57) ABSTRACT

The present invention relates to Group-based trust management scheme (GTMS) of wireless sensor networks. GTMS evaluates the trust of a group of sensor nodes in contrast to traditional trust management schemes that always focused on trust values of individual nodes. This approach gives us the benefit of requiring less memory to store trust records at each sensor node in the network. It uses the clustering attributes of wireless sensor networks that drastically reduce the cost associated with trust evaluation of distant nodes. Uniquely it provides not only a mechanism to detect malicious or faulty nodes, but also provides some degree of a prevention mechanism.

### BACKGROUND OF THE INVENTION

1. Field of the Invention

The present invention relates to trust management for wireless sensor networks.

2. Description of the Related Art

Research work on trust management schemes for wireless sensor networks is in its infancy state. To our knowledge, very few trust management schemes for these types of networks have been proposed such as RFSN[S. Ganeriwal and M. B. Srivastava, “Reputation-based framework for high integrity sensor networks,”, in Proc. Of ACM Security for Ad-hoc and Sensor Networks (SASN 2004), October 2004, pp. 66-67], ATRM[A. Boukerche, X. Li and K. EL-Khatib, “Trust-based security for wireless ad hoc and sensor networks,” Computer Communications, vol. 30, pp. 2413-2427, September 2007], and PLUS[Z. Yao, D. Kim, and Y. Doh, “PLUS:Parameterized and localized trust management scheme for sensor networks security,” in Proc. Of the 3^{rd} IEEE Int. Conf. on Mobile Ad-hoc and Sensor Systems (MASS 2006), Vancouver, Canada, October 2006, pp. 437-446]. Although, there are some other works available in the literature such as [K. Liu, N. Abu-Ghazaleh, and K.-D. Kang, “Location verification and trust management for resilient geographic routing,” Journal of Parallel and Distributed Computing, vol. 67, no. 2, pp. 215-228, 2007], [H. Chen, H. Wu, X. Zhou, and C. Gao, “Reputation-based trust in wireless sensor networks,” in Proc. Of International conference on Multimedia and Ubiquitous Engineering (MUE'07), Korea, April 2007, pp. 603-607], that discuses trust but not in much great detail.

In RFSN, each sensor node maintains the reputation for neighboring nodes only. Trust values are calculated on the basis of that reputation and it uses Bayesian formulation for representing reputation of a node. RFSN assumes that the node would have enough interactions with the neighbors so that the reputation (beta distribution) can reach a stationary state. However if the node mobility is at a higher rate, reputation information will not stabilize. In RFSN, nodes are classified into two categories: cooperative and not cooperative. In RFSN, no node is allowed to disseminate bad reputation information. If it is assumed that the “bad” reputation is implicitly included by not giving out good reputation then in that case, the scheme will not be able to cope with uncertainty situations.

ATRM scheme is based on a clustered wireless sensor network and calculates trust in a fully distributed manner. ATRM assumes that there is a single trusted authority which is responsible for generating and launching mobile agents that make it vulnerable against a single point of failure. ATRM also assumes that mobile agents are resilient against malicious nodes that try to steal or modify information carried by the agent. In many applications this assumption may not be realistic.

In PLUS scheme authors adopt a localized distributed approach and trust is calculated based on either direct observations or indirect observations. In this scheme, the authors assume that all the important control packets generated by the base station must contain a hashed sequence number(HSN). Inclusion of HSN in control packets not only increases the size of packets that results in higher consumption of transmission and reception power but also it increases the computational cost at the sensor nodes. Also, whenever a judge node receives a packet from another node i, it will always check the integrity of the packet. If the integrity check fails then the trust value of node i will be decreased irrespective of whether node i was really involved in making some modification in a packet maliciously or not. So node i may get unfair penalty.

### SUMMARY OF THE INVENTION

The present invention provides a new lightweight Group-based trust management scheme (GTMS) of wireless sensor networks. GTMS evaluates the trust of a group of sensor nodes in contrast to traditional trust management schemes that always focused on trust values of individual nodes. This approach gives us the benefit of requiring less memory to store trust records at each sensor node in the network. It uses the clustering attributes of wireless sensor networks that drastically reduce the cost associated with trust evaluation of distant nodes. Uniquely it provides not only a mechanism to detect malicious or faulty nodes, but also provides some degree of a prevention mechanism.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrate the sample scenario of the GTMS time window scheme according to an embodiment of the present invention.

### DETAILED DESCRIPTION OF THE PREFERRED EMBODIMENT

The present invention calculates the trust value based on direct or indirect observations. Direct observations represent the number of successful and unsuccessful interactions and indirect observations represent the recommendations of trusted peers about a specific node.

Interaction means cooperation of two nodes. For example, a sender will consider interaction as a successful interaction if he got assurance that the packet is successfully received by the neighbor node and he has forwarded it toward destination in an unaltered fashion.

First requirement of successful reception is achieved in reception of the link layer acknowledgment (ACK). IEEE 802.11 is a standard link layer protocol, which keeps packets in its cache until the sender received ACK. Whenever receiver node successfully received the packet he will send back ACK to the sender. If sender node did not received ACK during timeout then sender will retransmit that packet.

Second requirement is achieved with the help of using enhanced passive acknowledgments (PACK) by overhearing the transmission of a next hop on the route, since they are within radio range[S. Buchegger and J.-Y. L. Boudec, “Self-policing mobile ad hoc networks by reputation systems,” IEEE Communications Magazine, vol. 43, no. 7, pp. 101-107, July 2005].

If the sender node does not overhear the retransmission of the packet within a timeout from its neighboring node or overhead packet is found to be illegally fabricated (by comparing the payload that is attached to the packet) then the sender node will consider that interaction as an unsuccessful one. If the number of unsuccessful interactions increases, then the sender node decreases the trust value of that neighboring node and may consider it as a faulty or malicious node.

The trust model of the present invention is hybrid in nature, working with two topologies. One is the intra-group topology where distributed trust management is used. The other is inter-group topology where centralized trust management scheme is employed. For the intra-group network, each sensor that is a member of the group, calculates individual trust values for all group members. Based on the trust values, a node assigns one of the three possible states: 1) trusted, 2) un-trusted or 3) un-certain to other member nodes. This three-state solution is chosen for mathematical simplicity and found to provide the appropriate granularity to cover the situation. Then, each node forwards the trust state of all the group member nodes to the cluster-head. After that, centralized trust management takes over. Based on trust states of all group members, a cluster-head detects the malicious node(s) and forward a report to the base station. On request, each cluster-head also sends trust values of other cluster-heads to the base station. Once this information reaches the base station, it assigns one of the three possible states to the whole group. On request, the base station will forward the current state of a specific group to the cluster-heads.

The group based trust model of the present invention works in three phases: 1) Trust calculation at the node level, 2) Trust calculation at the cluster-head level, and 3) Trust calculation at the base station level.

1. Trust Calculation at the Node Level

At the node level, a trust value is calculated using either time-based past interaction or peer recommendations. Whenever a node y wants to communicate with node x, it first checks whether y has any past experience of communication with x during a specific time interval or not. If yes, then node x makes a decision based on past interaction experience, and if not, then node x moves for the peer recommendation method.

1) Time-Based Past Interaction Evaluation

Trust calculation at each node measures the confidence in node reliability. Here the network traffic conditions such as conjunction, delay etc., should not affect the trust attached to a node; this means that the trust calculation should not emphasize the timing information of each interaction too rigidly. Therefore a sliding time window concept was introduced in the present invention which takes relative time into consideration and reduces the effects of network conditions on overall trust calculation.

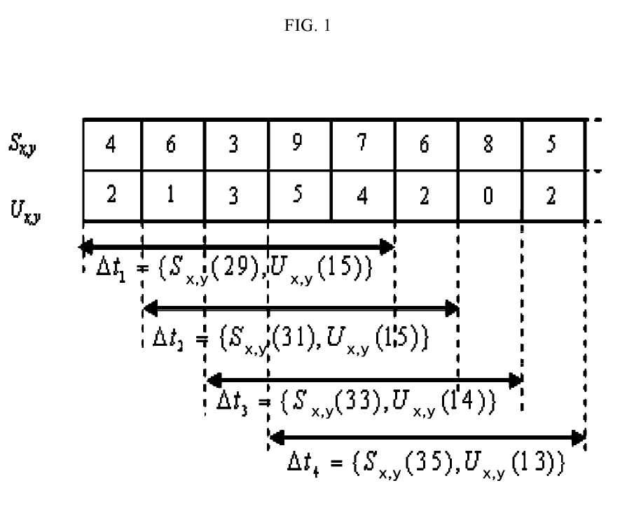

A timing window (Δt) is used to measure the number of successful and unsuccessful interactions. It consist of several timing units. The interactions in each time unit within the timing window that occur are recorded. After a unit of time elapses, the window slides one time unit to the right, thereby dropping the interactions done during the first unit. Thus, as time progresses, the window forgets the experiences of one unit but adds the experiences of the newer time unit. The window length could be made shorter or longer based on network analysis scenarios. A sample scenario of the GTMS time window scheme is illustrated in FIG. 1.

With this time window information, the time-based past interaction trust value (T_{x,y}) of node y at node x that lies between 0 and 100, is defined as;

$$\begin{matrix}{T}_{x , y} = [ 100 ( \frac{{S}_{x , y}}{{S}_{x , y} + {U}_{x , , y}} ) ( 1 - \frac{1}{{S}_{x , y} + 1} ) ] \\ = [ \frac{100 {( {S}_{x , y} )}^{2}}{( {S}_{x , y} + {U}_{x , y} ) ( {S}_{x , y} + 1 )} ]\end{matrix} \qquad ( 1 )$$

where [.] is the nearest integer function, S_{x,y} is the total number of successful interactions of node x with y during Δt time, U_{x,y} is the total number of unsuccessful interactions of node x with y during time Δt. The expression

$$( 1 - \frac{1}{{S}_{x , y} + 1} )$$

in the above approaches 1 rapidly with an increase in the number of successful interactions. We choose this function instead of a linear function since such a function would approach very slowly to 1 with the increase in successful interactions; hence it would take a considerably long time for a node to increase its trust value for another node. In order to balance this increase in the trust value with the increasing number of unsuccessful interactions, we multiply the expression with factor

$$( \frac{{S}_{x , y}}{{S}_{x , y} + {U}_{x , y}} ) ,$$

which indicates the percentage of successful interactions among the total interactions.

After calculating trust values, a node will quantize it into three states as follows:

$$Mp ( {T}_{x , y} ) = \{ \begin{matrix}trusted & 100 - f \leq {T}_{x , y} \leq 100 \\ uncertain & 50 - g \leq {T}_{x , y} < 100 - f \\ untrusted & 0 \leq {T}_{x , y} < 50 - g\end{matrix} \} \qquad ( 2 )$$

where, f represents the half of the average values of all trusted nodes and g represents the one third of the average values of all untrusted nodes. Both f and g are calculated as follows:

$$\begin{matrix}{f}_{j + 1} = \{ \begin{matrix}[ \frac{1}{2} ( \frac{{\sum }_{i ∈ {R}_{x}} {T}_{x , i}}{\vert {R}_{x} \vert} ) ] & 0 < \vert {R}_{x} \vert \leq n - 1 \\ {f}_{j} & \vert {R}_{x} \vert = 0\end{matrix} & ( 3 ) \\ {g}_{j + 1} = \{ \begin{matrix}[ \frac{1}{3} ( \frac{{\sum }_{i ∈ {M}_{x}} {T}_{x , i}}{\vert {M}_{x} \vert} ) ] & 0 < \vert {M}_{x} \vert \leq n - 1 \\ {g}_{j} & \vert {M}_{x} \vert = 0\end{matrix} & ( 4 )\end{matrix}$$

where [.] is the nearest integer function, Rₓ represents the set of trustful nodes for node x, Mₓ the set of untrustful nodes for node x, and n is the total number of nodes that contains trustful, un-trustful and uncertain nodes. At startup, the trust values of all nodes are 50 which is an uncertain state. Initially, f and g are equal to 25 and 17 respectively, although other values could also be used by keeping following constraint intact: fᵢ−gᵢ≧1, which is necessary for keeping an uncertain zone between a trusted and un-trusted zone.

The values of f, and g are adaptive. During the steady-state operation, these values can change with every passing unit of time that create dynamic trust boundaries. At any stage when |Rₓ| or |Mₓ| becomes zero then the values of fⱼ₊₁ or gⱼ₊₁ remain the same as the previous values (fⱼ and gⱼ). The nodes whose value is above 100−f will be declared as trustful nodes (Eq. 2), and nodes whose value is lower than 50−g will be consider as an untrusted node (Eq. 2). After each passage of Δt, nodes will recalculate the values of f and g. This trust calculation procedure will continue in this fashion.

2) Peer Recommendations Evaluation

Let a group be composed of n uniquely identified nodes. Futhermore, each node maintains a trust value for all other nodes. Whenever a node requires peer recommendation it will send request to all member nodes except the un-trusted ones. Let us assume that j nodes are trusted and uncertain in a group. Then node x calculates the trust value of node y as follows:

$${T}_{x , y} = [ \frac{{\sum }_{i ∈ {R}_{x} ⋃ {C}_{x}} {T}_{x , i} * {T}_{i , y}}{100 * j} ] ; \\ j = \vert {R}_{x} ⋃ {C}_{x} \vert \leq n - 2 \qquad ( 5 )$$

where, [.] is the nearest integer function, T_{x,i} is the trust value of recommender, and T_{i,y} is the trust value of node y sent by node i. Here T_{x,i} is acting as a weight value of the recommender that is multiplied with the trust value T_{i,y}, send by recommender, such that the trust value of node y should not increase beyond the trust value between node x and the recommender node i.

2. Trust Calculation at the Cluster-Head Level

Here we assume that the cluster-head is the sensor node that has higher computational power and memory as compared to other sensor nodes.

1) Trust State Calculation of Own Group

In order to calculate the global trust value of nodes in a group, cluster-head ask the nodes for their trust states of the other members in the group. We use the trust states instead of the exact trust values due to two reasons. First, the communication overhead would be less as only a simple state is to be forwarded to the cluster-head. Secondly, the trust boundaries of an individual node vary from other nodes. A particular trust value might be in a trusted zone for one node whereas it may only correspond to the uncertain zone for another node. Hence the calculation of the global trust state of nodes in a group would be more feasible and efficient if we only calculate it using the trust states.

Let us suppose there are n+1 nodes in the group including the cluster-head. The cluster-head will periodically broadcast the request packet within the group. In response, all group member nodes forward their trust states, s, of other member nodes to the cluster-head. The variable, s, can take three possible states: trusted, un-certain and un-trusted. The cluster-head will maintain these trust states in a matrix form, as shown below:

$${TM}_{ch} = [ \begin{matrix}{s}_{ch , 1} & {s}_{1 , ch} & … & {s}_{n , 1} \\ {s}_{ch , 2} & {s}_{1 , 2} & … & {s}_{n , 2} \\ ⋮ & ⋮ & ⋮ & ⋮ \\ {s}_{ch , n} & {s}_{1 , n} & … & {s}_{n , n - 1}\end{matrix} ] \qquad ( 6 )$$

where, TM_{ch} represents the trust state matrix of cluster-head ch and s_{ch,1} represents the state of node 1 at cluster-head ch. The cluster-head assigns a global trust state to a node based on the relative difference in trust states for that node. We emulate this relative difference through a standard normal distribution. Therefore, the cluster-head will define a random variable X such that:

$$X ( {s}_{i , j} ) = \{ \begin{matrix}2 & when & {s}_{i , j} = trusted \\ 1 & when & {s}_{i , j} = un \text{-} certain \\ 0 & when & {s}_{i , j} = un \text{-} trusted\end{matrix} \qquad ( 7 )$$

Assuming this to be a uniform random variable, we define the sum of m such random variables as Sₘ. The behavior of Sₘ will be that of a normal variable due to central-limit theorem [H. Tijms, Understanding Probabililty: Chance Rules in Everyday Life. Cambrideg: Cambridge University Press, 2004]. The expected value of this random variable is m and the standard deviation is √m/3. The cluster-head defines the following standard normal random variable for a node j:

$${Z}_{j} = \frac{\sqrt{3} ( X ( {s}_{ch , j} ) + {\sum }_{i = 1 , i \neq j}^{m} X ( {s}_{i , j} ) - m )}{\sqrt{m}} \qquad ( 8 )$$

If Zⱼ □[−1, 1] then the node j is termed un-certain, else if Zⱼ>1, it is called trusted. If Zⱼ<−1, it is labeled as un-trusted.

2) Trust Calculation of Other Groups

During group-to-group communications, the cluster-head maintain the record of past interactions of another group in the same manner as individual nodes keep record of other nodes. Trust values of a group is calculated on the basis of either past interaction or information passed on by the base station. Here we are nor considering peer recommendations from other groups in order to save transmission and reception power of cluster head node. Let us suppose cluster head i wants to calculate the trust value (T_{i,j}) of another cluster j, then it can be calculated by using either time-based past interaction(PI_{i,j}) evaluation or by getting recommendation from base station (BR_{i,j}) as shown below.

$${T}_{i , j} = \{ \begin{matrix}[ \frac{100 {( {S}_{i , j} )}^{2}}{( {S}_{i , j} - {U}_{i , j} ) ( {S}_{i , j} + 1 )} ] & if {PI}_{i , j} \neq ϕ \\ {BR}_{i , j} & if {PI}_{i , j} = ϕ\end{matrix} \} \qquad ( 9 )$$

If the cluster head does not have any record of past interactions within the time window means PI_{i,j}=φ, then, it requests the base station for the trust value.

3. Trust Calculation at Base Station Level

The base station also maintains the record of past interaction with cluster-heads in the same manner as individual nodes do as shown below.

$${T}_{BS , {ch}_{i}} = [ \frac{100 {( {S}_{BS , {ch}_{i}} )}^{2}}{( {S}_{BS , {ch}_{i}} - {U}_{BS , {ch}_{i}} ) ( {S}_{BS , {ch}_{i}} + 1 )} ] \qquad ( 10 )$$

where [.] is the nearest integer function, S_{BS,ch} is the total number of successful interactions of base station with cluster-head during Δt time, U_{BS,ch} is the total number of unseccessful interactions of base station with cluster-head during time Δt.

Let us suppose there are |G| groups in the network. Base station periodically multicast request packets to the cluster-heads. On request, the cluster-heads forward their trust vector related to the recommendations of other groups based upon past interactions to base station as shown below.

T̅_{ch}=(T_{ch,1},T_{ch,2}, . . . ,T_{ch,|G|-1}) (11)

On reception of trust vectors form all the cluster-heads, the base station will calculate the trust value of each group in manner shown below

$${T}_{BS , {G}_{1}} = [ \frac{{\sum }_{i = 1}^{\vert G \vert - 1} ( {T}_{BS , {ch}_{i}} ) ( {T}_{{G}_{i} , {G}_{1}} )}{\vert G \vert - 1} ] , … , \\ {T}_{BS , {G}_{m}} = [ \frac{{\sum }_{i = 1}^{\vert G \vert - 1} ( {T}_{BS , {ch}_{i}} ) ( {T}_{{G}_{i} , {G}_{\vert G \vert}} )}{\vert G \vert - 1} ] \qquad ( 12 )$$

where [.] is the nearest integer function, T_{BS,chi} is the trust value of the cluster-head i at the base station, T_{Gi,G1} is the trust value of group G₁ at group Gᵢ and |G| represents the number of groups in the network.

What is claimed is:

1. A method of trust management in wireless sensor networks, comprising the steps of:
each node in a group calculating individual trust values for all group members, assigning one of trust states based on the trust values to other nodes in the group and forwarding the assigned trust states to a cluster-head;
the cluster-head assigning a global trust state to each node based on the relative difference in trust states for the node.

2. The method according to claim 1, wherein said trust states include trusted, un-trusted and un-certain.

3. The method according to claim 2, if a node has any past experience between other nodes, then trust value is calculated using time-based past interaction.

4. The method according to claim 3, said time-based past interaction is calculated using the equation
$$\begin{matrix}{T}_{x , y} = [ 100 ( \frac{{S}_{x , y}}{{S}_{x , y} + {U}_{x , y}} ) ( 1 - \frac{1}{{S}_{x , y} + 1} ) ] \\ = [ \frac{100 {( {S}_{x , y} )}^{2}}{( {S}_{x , y} + {U}_{x , y} ) ( {S}_{x , y} + 1 )} ]\end{matrix}$$
wherein [.] is nearest integer function, S_{x,y} is the total number of successful interactions of node x with node y during predetermined time, U_{x,y} is the total number of unsuccessful interactions of node x with node y during the predetermined time.

5. The method according to claim 2, if a node does not have any past experience between nodes, then trust value is calculated using peer recommendations.

6. The method according to claim 5, node x calculates the trust value of node y using
$${T}_{x , y} = [ \frac{{\sum }_{i ∈ {R}_{x} ⋃ {C}_{x}} {T}_{x , i} * {T}_{i , y}}{100 * j} ] ;$$
$$j = \vert {R}_{x} ⋃ {C}_{x} \vert \leq n - 2$$
where, [.] is the nearest integer function, T_{x,i} is the trust value of recommender, and T_{i,y} is the trust value of node y sent by node i assuming that j nodes are trusted and uncertain in a group.

7. The method according to claim 2, each node will quantize trust values into three states using the following equation:
$$Mp ( {T}_{x , y} ) = \{ \begin{matrix}trusted & 100 - f \leq {T}_{x , y} \leq 100 \\ uncertain & 50 - g \leq {T}_{x , y} < 100 - f \\ untrusted & 0 \leq {T}_{x , y} < 50 - g\end{matrix} \}$$
wherein f is the half of the average values of all trusted nodes, g is the one third of the average values of all untrusted nodes.

8. The method according to claim 7, f is calculated using
$$\begin{matrix}{f}_{j + 1} = \{ \begin{matrix}[ \frac{1}{2} ( \frac{{\sum }_{i ∈ {R}_{x}} {T}_{x , i}}{\vert {R}_{x} \vert} ) ] & 0 < \vert {R}_{x} \vert \leq n - 1 \\ {f}_{j} & \vert {R}_{x} \vert = 0\end{matrix} \\ and g is calculated using \\ {g}_{j + 1} = \{ \begin{matrix}[ \frac{1}{3} ( \frac{{\sum }_{i ∈ {M}_{x}} {T}_{x , i}}{\vert {M}_{x} \vert} ) ] & 0 < \vert {M}_{x} \vert \leq n - 1 \\ {g}_{j} & \vert {M}_{x} \vert = 0\end{matrix}\end{matrix}$$
wherein Rₓ represents the set of trusted nodes for node x, Mₓ is the set of un-trusted nodes for node x, and n is the total number of nodes that contains trusted.

9. The method according to claim 2, said cluster-head defines a random variable X such that
$$X ( {s}_{i , j} ) = \{ \begin{matrix}2 & when & {s}_{i , j} = trusted \\ 1 & when & {s}_{i , j} = un \text{-} certain \\ 0 & when & {s}_{i , j} = un \text{-} trusted\end{matrix}$$
and for m such random variables said cluster-head defines the following standard normal random variable for a node j
$${Z}_{j} = \frac{\sqrt{3} ( X ( {s}_{ch , j} ) + {\sum }_{i = 1 , i \neq j}^{m} X ( {s}_{i , j} ) - m )}{\sqrt{m}}$$
wherein S_{ch,j} represents the state of node j at cluster-head ch,
and said cluster-head assigns the global trust state to each node such that if Zⱼ□[−1, 1] then the node j is assigned to be un-certain, if Zⱼ>1, trusted, and if Zⱼ<−1, un-trusted.

10. The method according to claim 2, a base station receives from each cluster-head the trust values of other cluster-heads and calculates the trust value of each group using
$${T}_{BS , {G}_{1}} = [ \frac{{\sum }_{i = 1}^{\vert G \vert - 1} ( {T}_{BS , {ch}_{i}} ) ( {T}_{{G}_{i} , {G}_{1}} )}{\vert G \vert - 1} ] , … , \\ {T}_{BS , {G}_{m}} = [ \frac{{\sum }_{i = 1}^{\vert G \vert - 1} ( {T}_{BS , {ch}_{i}} ) ( {T}_{{G}_{i} , {G}_{\vert G \vert}} )}{\vert G \vert - 1} ]$$
wherein T_{BS,chi} is the trust value of the cluster-head i at the base station, T_{gi,G1} is the trust value of group G₁ at group Gᵢ and |G| represents the number of groups in the network.

11. The method according to claim 10, the cluster-head requests the base station for the trust value of another cluster-head if it does not have any record of past interactions within a predetermined time window with said another cluster-head.

12. The method according to claim 10, the base station assigns one of the three possible states to the whole group based on the trust values.

13. The method according to claim 2, the cluster-head is a sensor node that has higher computational power and memory as compared to other sensor nodes.

14. The method according to claim 2, the cluster-head periodically broadcast the trust state request packet within the group.

15. The method according to claim 10,
the base station periodically multicast request packets to the cluster-heads, and
on request, the cluster-heads forward their trust vector related to the recommendations of other groups based on past interactions to base station as follows
T̅_{ch}=(T_{ch,1},T_{ch,2}, . . . ,T_{ch,|G|-1})
wherein T_{ch,i} represents the trust value of another cluster j calculated at cluster-head ch.
